(19) United States
(12) Patent Application Publication
(10) Pub. No.: US 2017/0024737 A1
(43) Pub. Date: Jan. 26, 2017

(54) FINANCIAL TRANSACTION METHOD AND SYSTEM

(71) Applicant: MasterCard International Incorporated, Purchase, NY (US)

(72) Inventors: Jaipal Singh Kumawat, Rajasthan Pin (IN); Gurpreet Atwal, Somers, NY (US); Vipul Mehrotra, New Delhi (IN)

(21) Appl. No.: 15/214,840

(22) Filed: Jul. 20, 2016

(30) Foreign Application Priority Data
Jul. 24, 2015 (SG) 10201505801U

(51) Int. Cl. G06Q 20/40; G06Q 20/10; G06Q 20/34

(52) U.S. Cl. CPC G06Q 20/409; G06Q 20/34; G06Q 20/102; G06Q 50/18

(57) ABSTRACT

A financial transaction system has a processing unit, a database unit and input-output interface. The system receives data from a mobile input-output device operated by a traffic law enforcement officer. That received data comprises data about a driver's licence which is linked (within the system) with a payment card. The system processes the input data so that financial penalties imposed for traffic violations are charged against the linked payment card.

### CROSS-REFERENCE TO RELATED APPLICATION

This application is a U.S. National Stage filing under 35 U.S.C. §119, based on and claiming benefit of and priority to SG Patent Application No. 10201505801U filed Jul. 24, 2015.

### FIELD OF THE INVENTION

The present invention relates to financial transactions, methods and systems. It is particularly suited to making of payments to government agencies for penalties which are imposed for breaches of the law and is described below in the context of the payment of penalties for traffic infringements.

### BACKGROUND ART

Various jurisdictions use differing mechanisms to receive payment of penalties or other fees which have been imposed for breaches of the law. A traditional mechanism involves the issue of a summons to the offender to attend a court which can impose a financial penalty, followed by the offender paying the fine in cash to a court official or other governmental officer. This mechanism is heavily dependent on manual processing, including the preparation of court documents by the enforcement officer, and the courts issuing a summons or the like. It also requires the maintenance of a records system to track the penalties which have been imposed by the courts, to track the timely compliance with payment of the penalty, and to follow-up with additional penalties where the fine has not been paid. The obligations imposed on the offender to attend court and to physically pay the fine are unnecessarily onerous and tend to inhibit compliance. Because cash transactions are involved, the administrative and auditing requirements need to be strict to prevent theft by, or bribery of, the officials involved.

More recently, with a view to more efficient and timely enforcement of laws, traffic law enforcement officers such as traffic police have been give power to issue “on-the-spot” infringement notices. These infringement notices impose a financial penalty which the offender again pays by payment in cash to a government official. However such systems also require manual processing and are still susceptible to bribery and corruption in the handling of cash. For example, the enforcement officer may tell the offender that the fine is higher than it is, and retain for himself or herself the difference between the true fine and what the offender pays.

There is thus a need for a more efficient system for the imposition of financial penalties for breach of the law, for tracking compliance with those penalties and for reducing the opportunities for theft or for bribery.

### SUMMARY OF THE INVENTION

It is an object of the embodiments described herein to overcome or alleviate at least one of the above noted drawbacks of related art systems or to at least provide a useful alternative to related art systems.

In a first aspect of the invention there is provided a computer-implemented financial transaction method, comprising:
a processing system receiving input data comprising first data specifying a legal violation and second data which has been gathered at least in part from a regulatory licence by the use of a first mobile input-output device,
the processing system using the second data to access a database, to identify a payment card which is linked to the regulatory licence and associated with a payment account;
the processing system using the first data to calculate output data (e.g. data comprising data indicating the level of a fine), and transmitting that output data to the first mobile input-output device; and
the processing system receiving an authorization to proceed with a financial transaction characterized by the output data (e.g. of the amount indicated by the output data); and
upon receiving the authorization, the processing system proceeding with the financial transaction using the identified payment card.

In a further aspect of the invention there is provided a financial transaction system, comprising:
a processing computer system which is adapted to perform processing steps comprising:
   receiving input data comprising first data specifying a legal violation and second data which has been gathered at least in part from a regulatory licence by the use of a first mobile input-output device,
   using the second data to access a database, to identify a payment card which is linked to the regulatory licence and associated with a payment account;
   using the first data to calculate output data, and transmitting that output data to the first mobile input-output device; and
   receiving an authorization to proceed with a financial transaction characterized by the output data; and
   proceeding with the financial transaction using the identified payment card.

The computer system may perform these steps by running software which is stored in a data storage device, such as a tangible data storage device storing the software as non-transitory program instructions.

Other aspects and preferred forms are disclosed in the specification and/or defined in the appended claims, forming a part of the description of the invention.

It will be seen that embodiments of the present invention can provide a number of benefits. For example, they allow for the avoidance of cash payments by the use of a payment card, in turn resulting in the more rapid and reliable collection of government revenue. Government agencies have the option of allowing a reduction in penalty levels when those penalties are paid by use of a payment card. They allow the automatic, central, recording of traffic violations and recording of payments of penalties. They allow members of the public to have on-line access information about traffic laws and they allow offenders to check that traffic police have accurately informed them about the level of appropriate penalty. They allow government agencies to track the offending records of drivers to allow remedial action against frequent offenders. They allow the gathering of data which will be useful in analysing the effectiveness of traffic laws, for deciding insurance premiums charged to the offenders, and for making policy decisions as to the appropriate penalties to be incorporated into the traffic laws.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

As used in this document, the term “payment card” refers to any suitable cashless payment device associated with a payment account. Thus the term includes physical cards such as a credit card, a debit card, a prepaid card, a charge card, a membership card, a promotional card, a frequent flyer card, an identification card, a prepaid card, a gift card. The physical payment card may carry payment account information, for example it may comprise a Primary Account Number (PAN) of a payment card. Alternatively, the payment card may be implemented in software in an electronic device such as a user's mobile communication device (e.g. smartphone or tablet computer). For example, the payment card may be an app or service running on the communication device which allows the user to make a payment, such as Apple Pay—(which is a trademark of Apple Inc.) or another digital wallet service, using an associated payment account.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein. In particular, although the preferred embodiments of the invention which are described below relate to the enforcement of traffic laws, the scope of the invention includes other environments in which governmental agencies recover payments or penalties which are imposed by operation of the law.

An embodiment of the invention will now be described for the sake of example only with reference to the following drawings in which:

FIG. 1 is a high-level block-schematic diagram of a system according to one embodiment of the invention;

FIG. 2 is a diagram showing the structure of a transactional database unit of the embodiment of FIG. 1; and

FIG. 3 is a flow diagram of processing according to the embodiment of FIG. 1.

### DETAILED DESCRIPTION OF THE EMBODIMENT

### 1. Apparatus

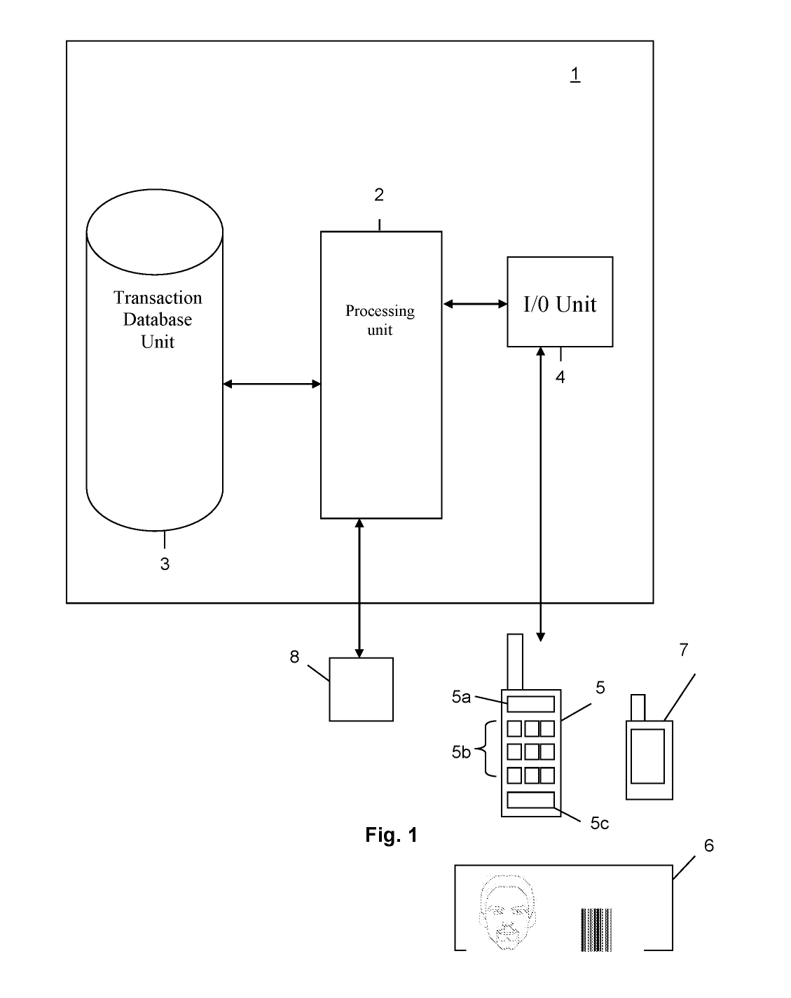

FIG. 1, illustrates a portion of a server system 1 according to one embodiment of the invention. The server system 1 comprises a processing unit 2, a database unit 3 and input-output interface 4. Under the control of the processing unit 2, the input-output interface 4 receives data from, and transmits data to, external devices and data is stored within the transaction database unit 3. The server system 1 is operated by a regulatory authority which also issues drivers' licences or like documents or cards to evidence the grant of some regulatory right. Alternatively, it is operated by a financial institution such as the operator of a payment network (for example, the financial institution may be MasterCard Incorporated Inc.) or an organisation (e.g. a bank) which issues the payment card.

The server system 1 uses the input-output interface 4 to communicate with mobile input-output devices used by enforcement offices. Only one such mobile input-output device 5 is shown for simplicity. The mobile input-output device 5 includes an interface for communicating wirelessly with the input-output interface 4 of the server. It further includes a screen 5a, a data-input mechanism 5b (such as one or more keys), and a mechanism 5c (such as an optical sensor, or an electronic and/or magnetic) sensor for reading data (such as a licence number) from the driving licence 6 of an offender. For this purpose the driving licence 6 may include a barcode or a magnetic strip encoding the number of the driving licence.

The mobile input-output device 5 and/or the input-output interface 4 may be enabled to communicate with a mobile input-output device 7 of an offender (e.g. a tablet computer, smartphone etc.).

Preferred forms of the connections between the input-output interface 4, the mobile input-output device 5 and the mobile input-output device 7 include private wireless data networks for connection with enforcement officers and the public mobile telephony and data networks for connection with enforcement officers and with offenders.

The server system 1 may also comprise a network-based interface 8 (preferably a Web interface over the Internet) by which offenders and other members of the public may interact with the server system 1 to:
access general information about the traffic laws;

register a payment card with the server system 1 so that it is linked with a driver's licence; and

download mobile apps into the offender's mobile input-output device 7 for communication with the server system 1.

In particularly preferred embodiments of the invention, either or both of the mobile input-output devices which are used by enforcement officers and by offenders comprise a geo-location capability for establishing the geographic location of that device. Preferred forms for the mobile input-output devices 7 to be used by offenders include mobile telephones and tablet devices which are running an app for communication with the server system 1.

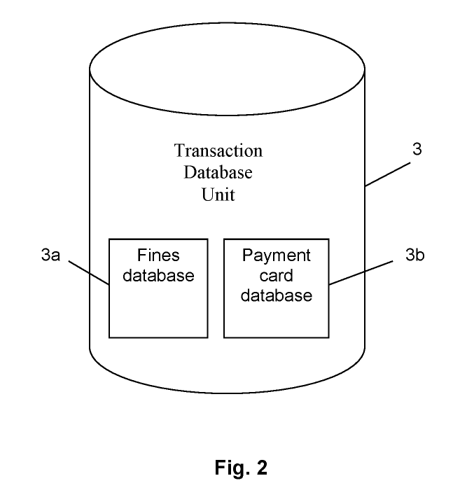

FIG. 2 illustrates the structure of the transactional database unit 3. Data stored within the transaction database unit 3 includes a fines database portion 3a storing data describing the traffic violations which are prohibited by the traffic law, the penalty, or range of penalties, which may be imposed for each violation, and a payment card database portion 3b storing data linking drivers' licences with the details of a respective payment card (preferably a debit card, credit card or stored-value card) against which penalties may be charged. The payment cards have been pre-registered with the regulatory authority for payment of penalties to the regulatory authority.

According to other preferred embodiments of the invention, the input-output interface 4 also provides connections with the transaction-processing facilities of financial institutions such as deposit-taking institutions and the issuers of payment cards such as debit-cards, credit-cards and stored-value cards.

### 2. Processing

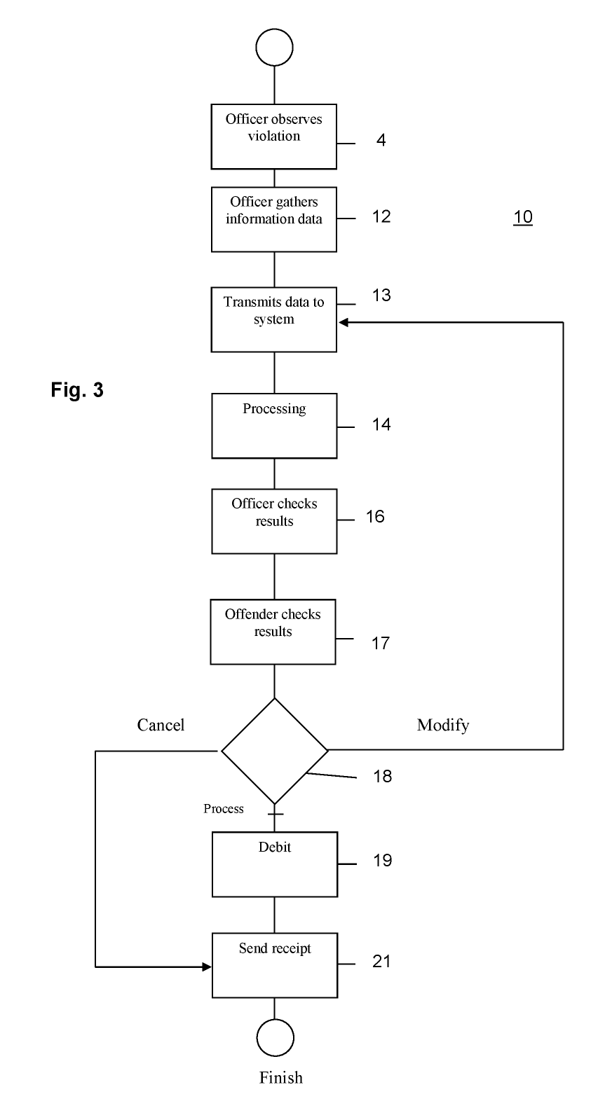

FIG. 3 illustrates aspects of processing 10 according to aspects of the presently-described embodiment of the invention.

According to a processing step which is not illustrated in FIG. 3, and which precedes the processing of FIG. 3, the holders of drivers' licences access the server system 1 and register a payment card with the server system 1 so that it is linked with a driver's licence.

As is illustrated in FIG. 3, at step 11 of the processing 10, an enforcement officer who observes a traffic violation stops or otherwise apprehends the driver.

At step 12 of the process the enforcement officer gathers information concerning the offender. According to the presently-described embodiment, that information gathering comprises the enforcement officer using their mobile input-output device to capture data about each offender's driver's licence. Preferred forms of data capture include the scanning of a driver's licence optically or electronically if the licence includes an electronically-readable medium. It this scanning operation fails, the enforcement office may enter data printed on the licence into the mobile input-output device using a keypad or a touch-sensitive screen. The driver's licence was previously linked with a payment card within the server system 1.

At step 13, the enforcement officer uses their mobile input-output device to transmit data to the server system 1. The data which is so transmitted comprises:
an identification of the relevant traffic offence;

data which has been gathered from the offender's drivers' licence or like documents or cards which have been issued by regulatory authorities; and

data which has been gathered by interrogation of the offender.

It is preferred that the data which is transmitted also comprises geo-location data which is generated by the mobile input-output device.

At step 14, the server system 1 performs processing and returns output from that processing to the enforcement officer's mobile input-output device. That processing comprises using data which has been input by the enforcement officer to interrogate the database unit 3, and returning results to the law enforcement officer's mobile input-output device. Those results include the level of financial penalty (“fine”) which has been imposed on the offender, as indicated by the fines database portion 3a. Note that the fine may be lower than the fine which an offender must pay if his or her payment card is not registered with the server system 1 and/or if the offender (as mentioned below) disputes the accuracy of the penalty rather than paying the fine at once. In other words, an incentive is offered for making an immediate payment, rather than paying later.

Optionally, at this time the payment card database portion 3b may be accessed also. This would also the amount of the fine to be discounted automatically depending on the type of card. For example, the regulatory authority might prefer payment by debit or prepaid card, rather than credit card.

At step 16, the enforcement officer checks the accuracy of the results which have been returned to their mobile input-output device for confirmation.

As is illustrated at step 17, it is preferred that those results are also shown to the offender who has an opportunity to confirm or dispute the accuracy of the results.

At step 18, the enforcement officer decides whether to proceed with the transaction (whether or not the offender has disputed accuracy), modify the transaction, or cancel the transaction. If the officer decides to modify the transaction, processing returns to step 13. If the officer decides to proceed with the transaction, processing continues to step 19.

At step 19, the offender's payment card is charged for the amount of the monetary penalty which has been imposed. In embodiments of the invention where the payment

card is a credit-card or a debit-card, the server system 1 communicates with the financial institution or card-issuer to record for recording and/or authorization of the monetary transaction as is required by the protocols of the card issuer.

At step 21, the system transmits a receipt for the offender. Preferred forms of receipt include a paper receipt which is printed by the enforcement officer's input-output device and an electronic receipt (such as an SMS message) which is transmitted to the offender's input-output device. The electronic receipt may be transmitted directly by the enforcement officer's input-output device, for example by a short-range communications protocol such as Bluetooth, or may be transmitted by the server system 1 via a communications network such as the Internet or a cellular network. In order to do so, the server system 1 may make use of a mobile phone number and/or email address which is associated with the regulatory licence in the transaction database unit 3.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer and for that matter, any commercial processor may be used to implement the embodiments of the invention either as a single processor, serial or parallel set of processors in the system and, as such, examples of commercial processors include, but are not limited to Merced™, Pentium™, Pentium II™, Xeon™, Celeron™, Pentium Pro™, Efficeon™, Athlon™, AMD™ and the like), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML. Moreover, there are hundreds of available computer languages that may be used to implement embodiments of the invention, among the more common being Ada; Algol; APL; awk; Basic; C; C++; Conol; Delphi; Eiffel; Euphoria; Forth; Fortran; HTML; Icon; Java; Javascript; Lisp; Logo; Mathematica; MatLab; Miranda; Modula-2; Oberon; Pascal; Perl; PL/I; Prolog; Python; Rexx; SAS; Scheme; sed; Simula; Smalltalk; Snobol; SQL; Visual Basic; Visual C++; Linux and XML.) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or

documented electronically using various tools, such as Computer Aided Design (CAD), a hardware description language (e.g., VHDL or AHDL), or a PLD programming language (e.g., PALASM, ABEL, or CUPL). Hardware logic may also be incorporated into display screens for implementing embodiments of the invention and which may be segmented display screens, analogue display screens, digital display screens, CRTs, LED screens, Plasma screens, liquid crystal diode screen, and the like.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. A computer-implemented financial transaction method, comprising:
a processing system receiving input data comprising first data specifying a legal violation and second data which has been gathered at least in part from a regulatory licence by the use of a first mobile input-output device,
the processing system using the second data to access a database, to identify a payment card which is linked to the regulatory licence and associated with a payment account;
the processing system using the first data to calculate output data, and transmitting that output data to the first mobile input-output device; and
the processing system receiving an authorization to proceed with a financial transaction characterized by the output data; and
upon receiving the authorization, the processing system initiating with the financial transaction using the identified payment card.

2. A computer-implemented financial transaction method as claimed in claim 1, in which the regulatory licence is a driver's licence, and the first data identifies a traffic offence.

3. A computer-implemented financial transaction method as claimed in claim 2, in which the output data comprises data identifying the level of financial penalty which has been imposed on a traffic offender.

4. A computer-implemented financial transaction method as claimed in claim 1, further comprising, after the transmitting of output data by the processing system but before the receiving of an authorization by the processing system:
the processing system receiving amended input data;
the processing system processing of that amended input data to generate amended output data; and
the processing system transmitting that amended output data to the first mobile input-output device.

5. A computer-implemented financial transaction method as claimed in claim 1, in which following the initiation of the financial transaction, the processing system processes the financial transaction.

6. A computer-implemented financial transaction method as claimed in claim 5, in which the processing system debits the financial transaction on the payment card which is linked with the electronically-readable medium.

7. A computer-implemented financial transaction method as claimed in claim 5, further comprising the step of sending a receipt for the financial transaction to at least a second mobile input-output device.

8. A computer-implemented financial transaction method as claimed in claim 1, in which the input data further comprises geo-location data which has been generated by, and identifies the location of the first mobile input-output device.

9. A financial transaction system, comprising:
a processing computer system which is adapted to perform processing steps comprising:
receiving input data comprising first data specifying a legal violation and second data which has been gathered at least in part from a regulatory licence by the use of a first mobile input-output device,
using the second data to access a database, to identify a payment card which is linked to the regulatory licence and associated with a payment account;
using the first data to calculate output data, and transmitting that output data to the first mobile input-output device; and
receiving an authorization to proceed with a financial transaction characterized by the output data; and
proceeding with the financial transaction using the identified payment card.

10. A financial transaction system according to claim 9 in which the processing system is adapted to calculate the output data by steps including accessing a database of fines corresponding to legal violations.

11. A financial transaction system as claimed in claim 9, in which the processing computer system is further adapted to perform processing steps comprising, after the transmitting of output data by the processing system but before the receiving of an authorization by the processing system:
receiving amended input data;
processing that amended input data to generate amended output data; and
transmitting that amended output data to the at least first mobile input-output device.

12. A financial transaction system as claimed in any one of claim 9, in which the processing computer system is further adapted to perform steps comprising the processing of the financial transaction.

13. A financial transaction system as claimed in claim 12, in which the processing computer system is further adapted to perform steps comprising the sending of a receipt for the financial transaction to at least a second mobile input-output device.

14. A financial system as claimed in any one of claim 9, in which the input data further comprises geo-location data which has been generated by, and identifies the location of, the first mobile input-output device, the financial system being arranged to store the location data.

15. A financial transaction system as claimed in claim 9, in which the input data further comprises data which identifies a traffic offence, the financial system being arranged to store information characterizing for each of a number of traffic law offenders, which traffic offence(s) they have committed.
